(19) United States
(12) Patent Application Publication
(10) Pub. No.: US 2003/0204933 A1
(43) Pub. Date: Nov. 6, 2003

(54) Turn-fixing mechanism for stroller wheel sets

(76) Inventor: Chuan-Ming Yeh, Chia-I Hsien (TW)

Correspondence Address: BIRCH STEWART KOLASCH & BIRCH, PO BOX 747, FALLS CHURCH, VA, 22040-0747, US

(21) Appl. No.: 10/428,856

(22) Filed: May 5, 2003

(30) Foreign Application Priority Data
May 6, 2002 (TW) 091206420

(51) Int. Cl. B60B 33/00

(52) U.S. Cl. 16/35 R

(57) ABSTRACT

A turn-fixing mechanism for stroller wheel sets mainly employs a connection element which has one end connecting to a latch plug to control turning release and locking of the a wheel set and another end connecting to a remote control member. The remote control member is mounted on a selected location of the frame. The latch plug may be actuated through the operation of the remote control member thereby users can control direction anchoring or turning of the wheel set while moving the stroller without going in front of the wheel set.

### FIELD OF THE INVENTION

The invention relates to a turn-fixing mechanism for stroller wheel sets that has a remote control part to control anchoring of the turning direction of a wheel set through a connection element, to enable users to select the turning direction of the wheel set on the frame.

### BACKGROUND OF THE INVENTION

Conventional strollers generally have a turning wheel set coupled on the front wheel tube or rear wheel tube to facilitate moving and turning of the strollers (the handle tube being used to change the moving direction). The wheel set further has an anchor structure to enable the wheel set to swivel freely or anchor in one direction. FIG. 1 illustrates such an example. The wheel set is coupled on a leg tube 10. It consists of a wheel holder 1, a wheel axle 11, a foot pedal 12 and an anchor member 13. The wheel axle 11 is fixedly coupled on the leg tube 10 and has an anchor hole 14. The wheel holder 1 is latched on the wheel axle 11 and may be swiveled about thereof. The anchor member 13 is located in the wheel holder 1 and may be coupled with the anchor hole 14 of the wheel axle 11 for anchoring, so that the wheel set is anchored on a selected turning direction or swiveled in varying directions as desired. The wheel set anchor mechanism for the conventional strollers mentioned above mainly uses the foot pedal as control. The foot pedal is pivotally coupled on the wheel holder. When users want to control the turning direction of the wheel set, they have to move in front of the wheel set to operate. This is quite inconvenient.

### SUMMARY OF THE INVENTION

The primary object of the invention is to resolve the disadvantages of the conventional anchor mechanisms for stroller wheel sets mentioned above. The invention mainly employs a connection element having one end connecting to a latch plug for controlling release and latch of the wheel set and another end connecting to a remote control member. The remote control part is located on a suitable position of the frame. It actuates the latch plug through the connection element. Thereby, users may control turning and anchoring or free swiveling of the wheel set without going in front of the wheel set while moving the stroller.

The foregoing, as well as additional objects, features and advantages of the invention will be more readily apparent from the following detailed description, which proceeds with reference to the accompanying drawings. The drawings are only to serve for reference and illustrative purposes, and are not intended to limit the scope of the invention.

### BRIEF DESCRIPTION OF THE DRAWINGS

FIG. 1 is a schematic view of a conventional structure.

FIG. 2 is a fragmentary schematic view of a first embodiment of the invention.

FIG. 3A is a schematic cross section of a first embodiment of the invention, showing the wheel set in a turn-fixing condition.

FIG. 3B is a schematic cross-section of a first embodiment of the invention, showing the wheel set in an unanchored condition.

FIG. 4 is a schematic view of a second embodiment of the invention.

FIG. 4A is a fragmentary perspective view of the wheel set in the second embodiment.

FIG. 4B is another schematic view of the second embodiment of the invention.

FIG. 5A is a schematic view of a third embodiment of the invention (with the wheel set in a turning condition).

FIG. 5B is a schematic view of the third embodiment of the invention (with the wheel set in a direction anchoring condition).

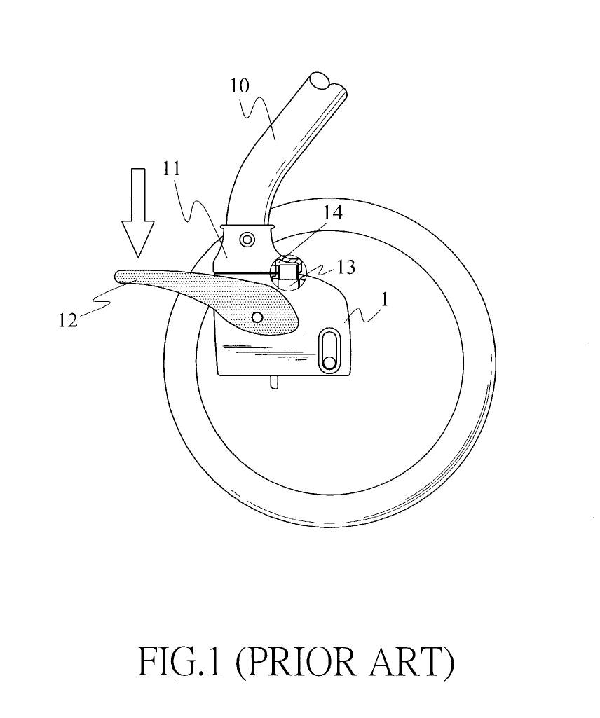

### DESCRIPTION OF THE PREFERRED EMBODIMENTS

Embodiment One:

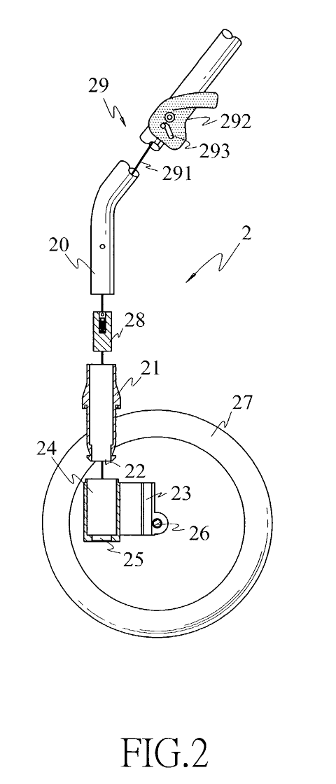

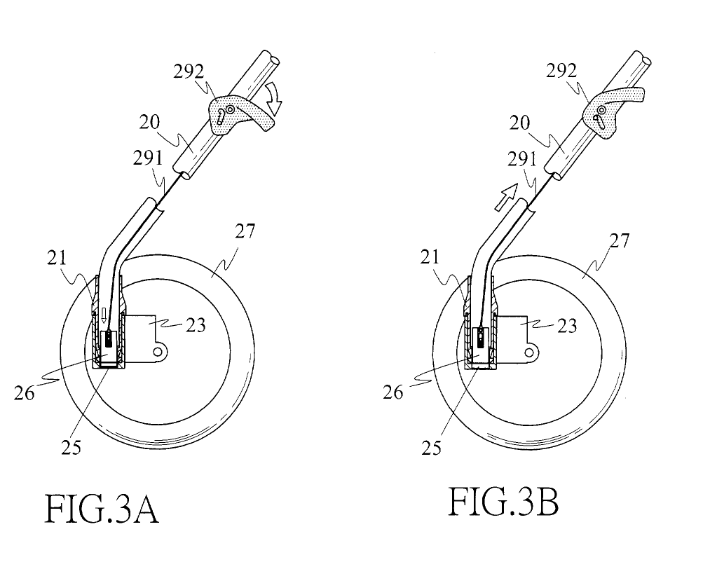

Referring to FIGS. 2, 3A and 3B, the turn-fixing mechanism for stroller wheel sets, according to the invention, is located on a lower end of a leg tube 20 of a stroller frame 2. The mechanism includes:

a shaft 21 which has one end fixedly coupled on a lower end of the leg tube 20 and another end, forming an opening 22;

a wheel holder 23 which has a housing space 24 for holding the shaft 21 so that the wheel holder 23 may be coupled with the shaft 21 and turn freely about (or around??) the shaft 21. The housing space 24 has an anchor hole 25. The wheel holder 23 further has two lateral sides pivotally coupling with a stroller wheel 27 through a transverse shaft 26;

a latch plug 28 located in the leg tube 20. It can run through the opening 22 of the shaft 21 to engage with the anchor hole 25 of the wheel holder 23 so that the latch plug 28 is latched between the shaft 21 and the wheel holder 23 to anchor the wheel holder 23 on a selected direction without swiveling freely. The latch plug 28 also can escape from the anchor hole 25 to free the wheel holder 23 from the constraint and turn freely to change turning direction.

A hauling mechanism 29 consisting of a connection element 291 and a remote control part 292. The remote control part 292 is spaced from the wheel holder 23 and mounted on a selected location of the frame. It includes at least a driving slot 293. The connection element 291 has one end connecting to the latch plug 28 and another end connecting to the driving slot 293 of the remote control part 292. Thus turning of the remote control part 292 can drive and move the latch plug 28 through the connection element 291, thereby directly controlling the turning or direction anchoring of the wheel holder.

Embodiment Two:

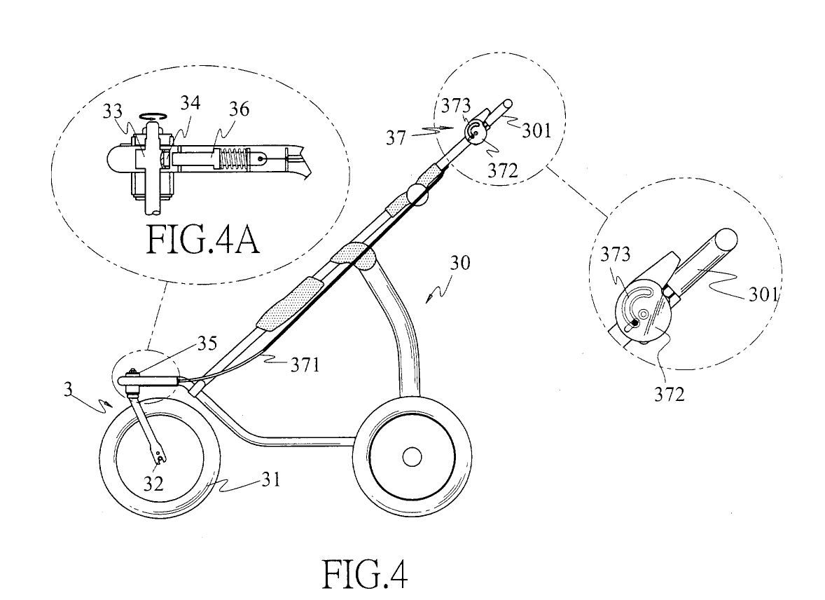

Referring to FIGS. 4 and 4A, the turn-fixing mechanism for stroller wheel sets, according to the invention, is adopted for use on a three-wheel stroller frame 30. It, includes:

a wheel holder 3, mounted on a lower section of the front end of the stroller frame 30. It has a front fork for holding the wheel 31 and a transverse shaft 32 to couple pivotally with the stroller wheel 31. The wheel holder 3 has another end connecting to a shaft 33. The surface of the shaft 33 has at least one anchor hole 34;

an axle dock 35 which has a shaft 33, located in the center and standard to the transverse axle 32. The wheel holder 3 swivels freely around the shaft 33;

a latch plug 36 located in the frame 30. It inserts into the anchor hole 34 of the shaft 33 of the wheel holder 3 to anchor the wheel 31 at a selected direction without swiveling freely. The latch plug 36 also can escape from the anchor hole 34 to free the wheel holder 3 from constraint and turn freely, to change turning direction. Moreover, the latch plug 36 can also be located on the wheel holder 3 (as shown in FIG. 4B). It also can be driven by a connection element 371 and be actuated by a levering method to escape from, or latch on the anchor hole 34; and

a hauling mechanism 37 consisting of a connection element 371 and a remote control part 372. The remote control part 372 is spaced from the wheel holder 3 and mounted on a selected location on the frame 30. In this embodiment, it is mounted on a handle tube 301 to enable users to operate while moving the stroller. The remote control part 372 includes at least one driving slot 373. The connection element 371 has one end connecting to the latch plug 36 and another end connecting to the driving slot 373 of the remote control part 372. Thus turning of the remote control part 372 can drive and move the latch plug 36 through the connection element 371, thereby directly controlling turning or direction anchoring of the wheel holder 3.

Embodiment Three:

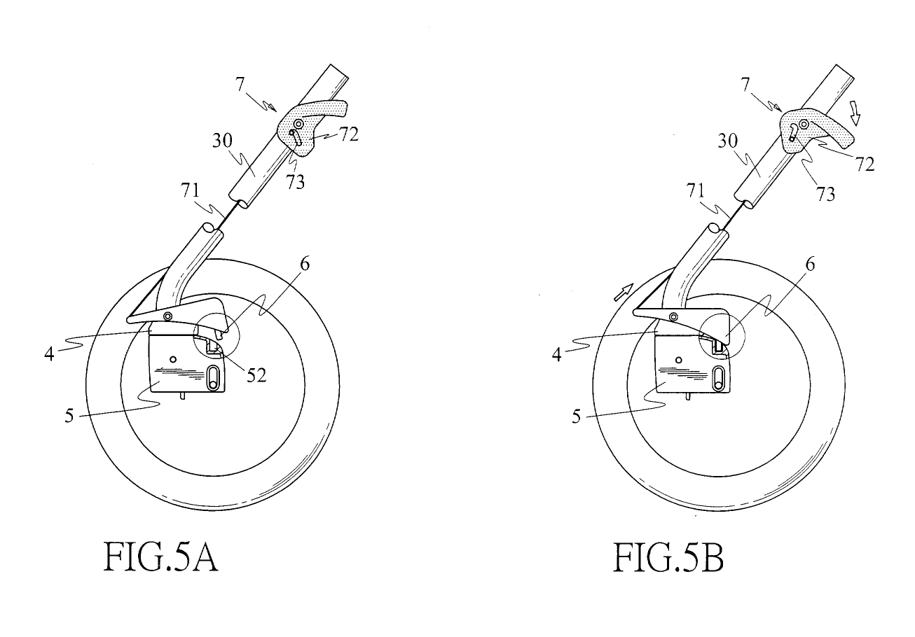

Referring to FIGS. 5A and 5B, this embodiment mainly includes:

a shaft 4 having one end fixedly coupled on a lower end of a leg tube 40;

a wheel holder 5 which has a housing space (not shown in the drawings) for holding the shaft 4 so that the wheel holder 5 can be coupled with the shaft 4 and turn freely around the shaft 4. The wheel holder 5 has an anchor hole 52;

a latch plug 6 pivotally engaged with the shaft 4 for engaging with the anchor hole 52 of the wheel holder 5, and is latched between the shaft 4 and the wheel holder 5 to anchor the wheel holder 5 in a selected mode without swiveling freely; the latch plug 6 can also be moved away from the anchor hole 50 to free the wheel holder 5 from constraint for turning freely.

A hauling mechanism 7 consisting of a connection element 71 and a remote control member 72. The remote control part 72 is spaced from the wheel holder 5 and mounted on a selected location of the frame. It enables users to operate while moving the stroller. The remote control part 72 includes at least a driving slot 73. The connection element 71 has one end connecting to the latch plug 6 and another end connecting to the driving slot 73 of the remote control part 72. Thus turning of the remote control member can drive and move the latch plug 6 through the connection element 71, thereby directly controlling swiveling or direction anchoring of the wheel holder.

By means of the construction, assembly and operations set forth above, it is clearly that through a remote control part and a connection element, the invention directly controls direction anchoring of the wheel set or enables the wheel set to swivel freely.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments not departing from the spirit and scope of the invention.

What is claimed is:

1. A turn-fixing mechanism for stroller wheel sets located on a leg tube of a stroller wheel set to selectively lock the turning direction of the wheel set or release the lock, the mechanism comprising:
a wheel holder which has one end holding a transverse shaft to pivotally couple with a stroller wheel and another end forming a housing space and at least one anchor hole;
a shaft fixedly coupled on a lower end of the leg tube to couple with the housing space of the wheel holder to allow the wheel holder to turn about the shaft freely to change turning direction;
a latch plug insertable into the anchor hole to anchor the wheel holder in a selected direction without turning freely and releasable from the anchor hole to allow the wheel holder to swivel freely to change the turning direction; and
a hauling mechanism connecting to the latch plug through a connection element and connecting to a remote control member which is remote from the wheel holder thereby to control the latch plug remotely to selectively anchor or release the turning direction of the wheel holder.

2. The turn-fixing mechanism for stroller wheel sets of claim 1, wherein the connection element is a steel cable which pulls the latch plug to insert into the anchor hole to anchor the wheel holder in a selected turning direction.

3. The turn-fixing mechanism for stroller wheel sets of claim 1, wherein the anchor hole is located on the bottom of the housing space of the wheel holder.

4. The turn-fixing mechanism for stroller wheel sets of claim 1, wherein the anchor hole is located on an outer side of the wheel holder.

5. The turn-fixing mechanism for stroller wheel sets of claim 1, wherein the remote control member of the hauling mechanism has at least one driving slot connecting to one end of the connection element.

6. A turn-fixing mechanism for stroller wheel sets located on a stroller frame to selectively lock the turning direction of the wheel sets or release the lock, the mechanism comprising:
a wheel holder which has one end holding a transverse shaft to pivotally couple with a stroller wheel and another end having a shaft which has at least one anchor hole formed on the surface thereof;
an axle dock fixedly fastened to a lower end of the frame to couple with the shaft to allow the wheel holder to turn freely about the shaft to change turning direction;
a latch plug insertable into the anchor hole to anchor the wheel holder in a selected direction without turning freely and releasable from the anchor hole to allow the wheel holder to turn freely to change the turning direction; and
a hauling mechanism connecting to the latch plug through a connection element and connecting to a remote control member which is remote from the wheel holder thereby to control the latch plug remotely to selectively anchor or release the turning direction of the wheel holder.

7. The turn-fixing mechanism for stroller wheel sets of claim 6, wherein the connection element is a steel cable which pulls the latch plug to escape from the anchor hole to allow the wheel holder to turn freely about the shaft.

8. The turn-fixing mechanism for stroller wheel sets of claim 6, wherein the remote control member of the hauling mechanism has at least one driving slot connecting to one end of the connection element.
